(19) United States
(12) Patent Application Publication
(10) Pub. No.: US 2014/0244288 A1
(43) Pub. Date: Aug. 28, 2014

(54) Method Of Providing Affordable Prescription-Drug Options Through A Point Of Care System

(71) Applicant: Tina Lorraine GOODMAN, Austin, TX (US)

(72) Inventor: Tina Lorraine GOODMAN, Austin, TX (US)

(73) Assignee: WENO EXCHANGE LLC, Austin, TX (US)

(21) Appl. No.: 14/192,868

(22) Filed: Feb. 27, 2014

Related U.S. Application Data
(60) Provisional application No. 61/770,069, filed on Feb. 27, 2013.

(51) Int. Cl. G06Q 50/22

(52) U.S. Cl. CPC G06Q 50/22
USPC 705/2

(57) ABSTRACT

A software application that analyzes different formularies provides a patient with affordable prescription-drug options through a point of care system. The software application uses a database to store healthcare plan formularies, cash-payment formulary, drug manufacturer copayment-assistance formularies, and drug manufacturer cash-discount formularies. All of the formularies on the database are provided in an interoperable format. The software application will compare and analyze the costs, the exclusion factors, and the discounts from the various applicable formularies for a specific drug and alternative drugs. This analysis will be presented as a certified screen to the prescriber or the patient in order to find the drug option that is both clinically relevant and affordable. The prescription and the certified screen details, less patient identifying information, will be sent as feedback to the benefit providers of those formularies.

The current application claims a priority to the U.S. Provisional Patent application Ser. No. 61/770,069 filed on Feb. 27, 2013.

### FIELD OF THE INVENTION

The present invention relates generally to a system and method for expertly compiling cost and benefit data from a variety of resources in order to provide assurance that the prescription selection screen is capable of legally optimizing and displaying all patient's drug benefit data available in order for both patient and/or prescriber user to make more informed prescription therapy decisions and to legally share the results as necessary. More specifically, values from, at least, the following data resources; the patient or patient's record, a drug data base, payer sources, the drug manufacturer, and discount card programs, are expertly aggregated with cost and benefit results displayed to the user on a computer screen which facilitates well informed prescription treatment options and then legally shares details of the screen outcome with others, while maintaining compliance with the patient's privacy rights.

### BACKGROUND OF THE INVENTION

Since 2008 electronic prescribing has increased tenfold. While this has improved the prescribing process, the prescriber system can only currently access formularies from a patient's health plan so the drug cost can only be shown as it relates to the health plan's formulary status. Third party benefit providers such as drug manufacturer coupons and cash discount programs also offer patient benefits, but these benefits stand-alone and are not computer readable. Therefore, they are not compatible for overall processing on the prescriber's point of care screen which shows only the health plan drug benefits. This results in prescribers being driven to prescribe drugs promoted by a health plan. They may overlook other viable brand name options which may or may not be in the patient's health plan's formulary. If the patient or prescriber did learn of a 3rd party discount or benefit available and decided on the drug therapy on the basis of using the discount, he or she may realize the benefit was not pre-qualified after it is too late. The patient may end up paying a higher price at the pharmacy counter, or they may decide not to fill the prescription due to the high cost. They also may call the prescriber back to get another prescription and be frustrated with the outcome.

This invention provides a means for prescriber systems to electronically read and process all of a patient's known health plan and 3rd party drug benefits, including the cash discount price for the prescription. These benefits are pre-qualified before they are presented, thus giving the prescriber and patient more therapy options. Once the patient and prescriber are privy to knowing the drug cost as it relates to all benefits available, including the cash pay option, the patient and prescriber may agree a brand name is both affordable and a better treatment to get the patient to the desired therapeutic outcome. For instance, the patient may have a choice between paying $5 for a generic drug or $40 for a faster acting drug or a drug that only needs to be administered once daily versus 4 times a day.

When affordability is paired with clinical relevance, the results are very positive. Patients will have less sticker shock at the pharmacy counter, be more likely to adhere to their therapy and benefit from the treatment ordered. This will result in overall better healthcare outcomes and far less administration on the pharmacy and prescriber's part.

The invention also helps benefit providers, because the prescription selection screen data and results are being shared back with all participating data providers, so they can manage their benefits and offers to patients and prescribers to get better outcomes.

Affordable healthcare is critical, and this invention makes it possible for drugs to show a realistic drug cost before a prescription is written. In the worst case scenario, when the patient has no health plan coverage, the invention provides a method to show the cash value and the cash value with any cash discount programs available, so virtually every patient can have cost reduction benefits known to them at the point of care. In addition, making the cash price known to the prescriber also helps the prescriber and patient become more aware of the overall cost of a treatment, when just seeing a co-pay or tier level may not bring this awareness.

### BRIEF DESCRIPTION OF THE DRAWINGS

FIG. 1 is an overall system view of the present invention.

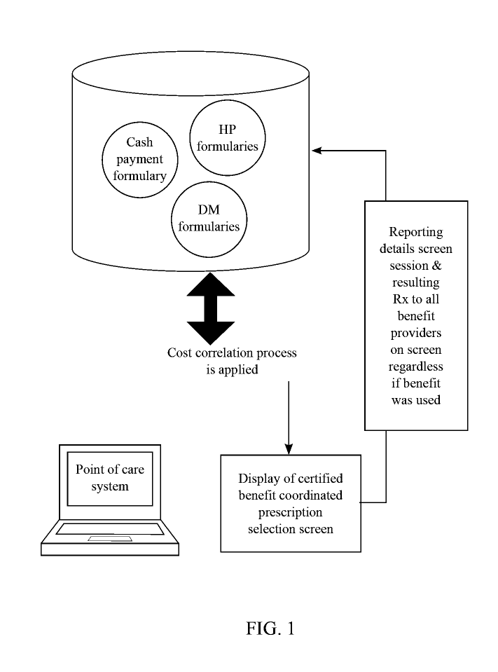

FIG. 2 is a block diagram illustrating the relationship between a patient and formularies for the present invention.

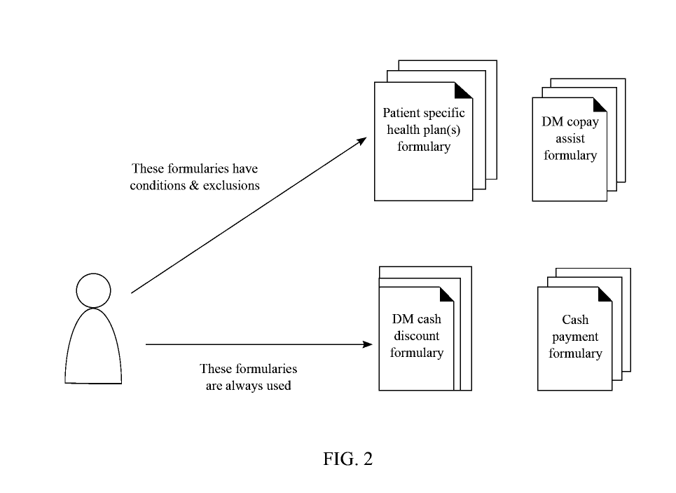

FIG. 3 is a block diagram illustrating the standard formulary data file format for the present invention.

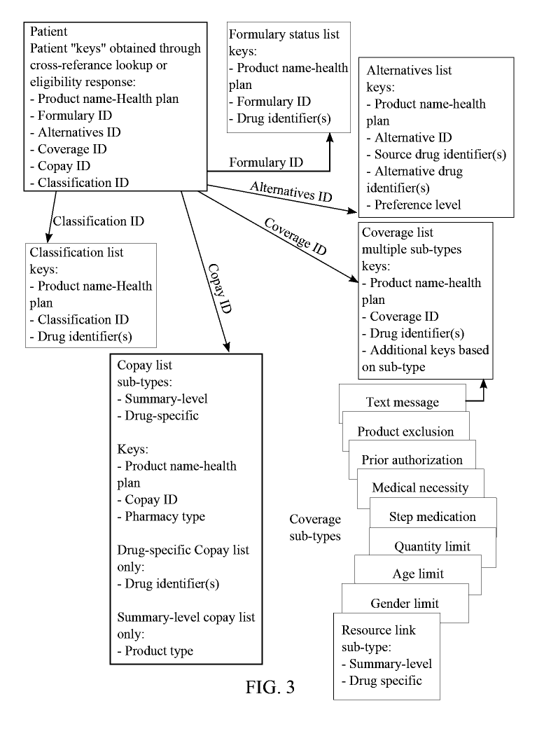

FIG. 4 is a flowchart outlining the HP formulary status determining process for the present invention.

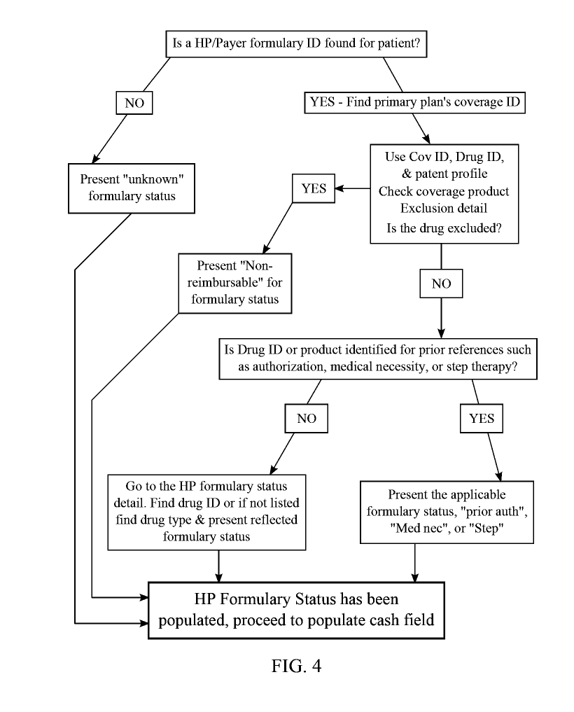

FIG. 5 is a flowchart outlining the cash payment value determining process for the present invention.

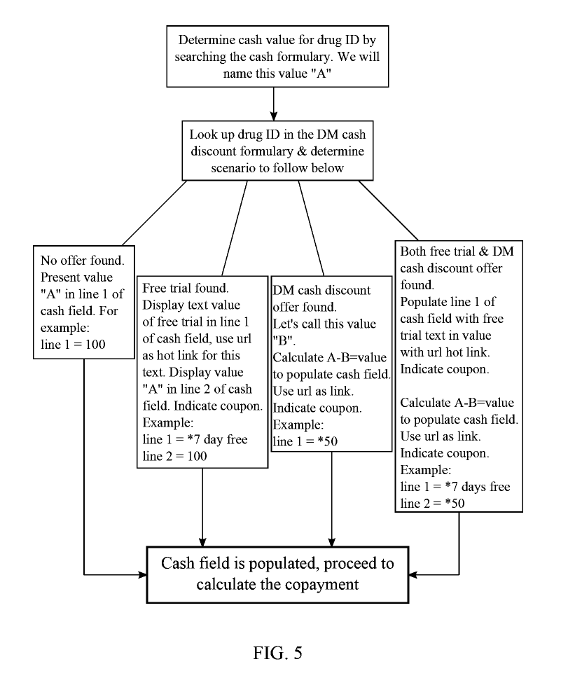

FIG. 6 is a flowchart outlining the copayment value determining process for the present invention, wherein the values in FIG. 5 correspond to the values in FIG. 6.

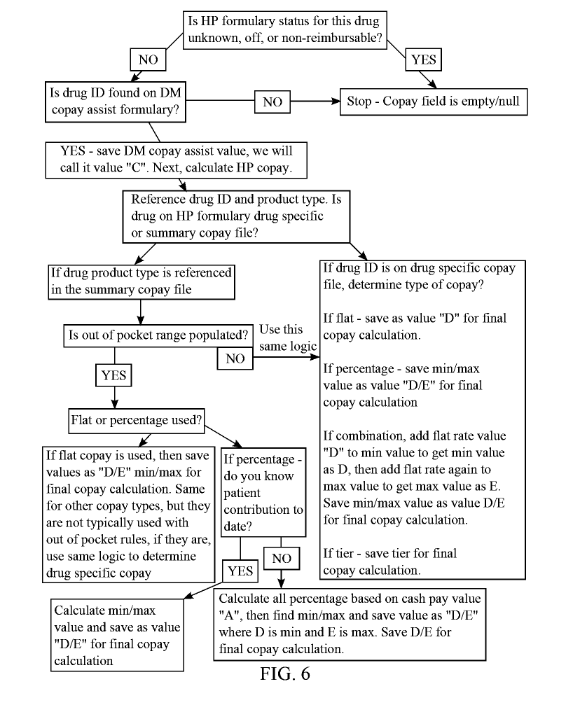

FIG. 7 is a chart outlining the copayment display rationale for the present invention, wherein the values in FIG. 6 correspond to the values in FIG. 7.

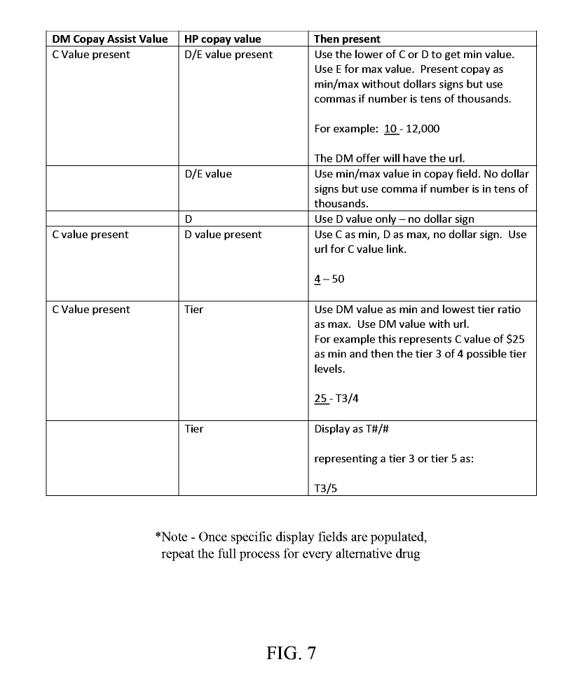

FIG. 8 is a block diagram illustrating the interoperable formulary data file format for the third party benefit providers for the present invention.

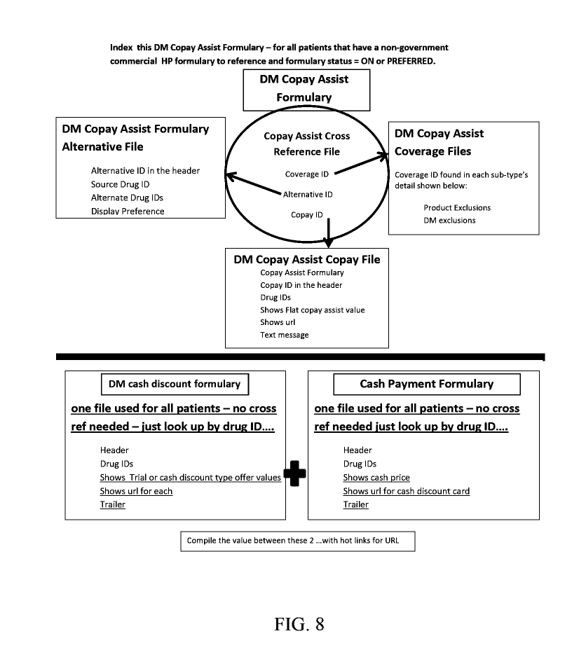

### DETAILED DESCRIPTIONS OF THE INVENTION

All illustrations of the drawings are for the purpose of describing selected versions of the present invention and are not intended to limit the scope of the present invention.

The present invention is a software system used by a point of care (POC) system to determine more affordable prescription-drug options for a patient. The present invention is designed to reduce a patient's overall medical expenses and, in turn, increase the patient's adherence to their prescription schedule. The present invention is provided with a formulary database, which allows all cost-related information about different prescription drugs to be accessed from a central point. The formulary database includes a plurality of healthcare plan (HP) formularies and a plurality of third party formularies. Each of the HP formularies is a list of prescription drugs that the corresponding healthcare plan is willing to pay for. Each of the third part formularies provides alternative offers to discount different prescription drugs. The third party formularies include a cash-payment formulary, a plurality of drug manufacturers (DM) copayment-assistance formularies, and a plurality of DM cash-discount formularies. The cash-payment formulary is a list of prescription drugs that are discounted when those prescription drugs are paid for in cash. Each of the DM copayment-assistance formularies is a list of prescription drugs that the corresponding drug manufacturer is willing to reduce the copayment for. Each of the DM cash-discount formularies is a list of prescription drugs that are further discounted by the corresponding drug manufacturer when those prescription drugs are paid for in cash. These third party formularies are provided in an interoperable format with the plurality of HP formularies so that information can be efficiently accessed, cross referenced, and managed within the formulary database. The present invention allows the POC system of any prescriber to access the formulary database.

The present invention implements an overall process in order to determine and present more affordable prescription-drug options through the POC system. The overall process begins by receiving a drug search query for a patient profile through the POC system. The drug search query allows the present invention to identify the specific drug amongst a number of prescription drugs. The specific drug will have drug description information such as the specific drug's name, dosage, dispensing form, and manufacturer. The patient profile allows the present invention to distinguish a patient amongst other patients. The patient profile includes personal health information. The overall process continues by searching through the HP formularies, the cash-payment formulary, the DM copayment-assistance formularies, and the DM cash-discount formularies in order to find matching references to the specific drug and the patient profile, which allows the present invention to collect the necessary data to complete and to determine a cost analysis and purchase options for the specific drug. These matching references include, but are not limited to, cost coverage from a healthcare plan, cost reduction for a cash payment, cost reduction from a drug manufacturer for a cash payment, copayment assistance from a drug manufacturer, or alternative drugs.

The overall process proceeds by performing a cost correlation process for the specific drug. The cost correlation process uses the matching references as input data and determines the output data as an HP formulary status for the patient profile, an overall copayment value, an overall cash-discount value, and alternative-drugs information. The HP formulary status indicates whether or not the specific drug is covered by the patient's healthcare plan. The overall copayment value is how much the patient needs to pay for their healthcare plan's copayment after any applicable discounts are applied. The overall cash-discount value is how much the patient would need to pay out of pocket after any applicable discounts are applied. The alternative drug information allows the prescriber or the patient to know the cost of prescription drugs that can be taken instead of the specific drug. Once the output data is compiled by the present invention, the overall process continues by displaying a certified screen though the POC system. The certified screen includes the HP formulary status, the overall copayment value, the cash discount value, and the alternative-drugs information. The certified screen allows the prescriber or the patient to trust the output data that is provided to them through the POC system because the present invention compiled and verified the output data. In addition, the certified screen could further include formulary coverage details for the specific drug so that the prescriber or the patient can easily access and view them.

Finally for the overall process, if the POC system writes a prescription for the specific drug, then the present invention will generate and send a usage report to the benefit-providing participants. The usage report contains the details of the prescription and the certified screen without patient-identifying information. The patient-identifying information is not included within the usage report because of adherence to the Health Insurance Portability and Accountability Act (HIPAA). The present invention will identify the third party benefit-providing participants by looking at who provided discount and cost reduction offers that were integrated into the output data for the specific drug. Thus, these third party benefit-providing participants can be found by reading through the certified screen.

The present invention implements a secondary process in order to determine the HP formulary status. In order to implement this secondary process, the patient profile must include at least one HP identification, which means the patient is on at least one healthcare plan. In some cases, the patient may have a primary healthcare plan and a secondary healthcare plan, which means the patient profile should respectively include a primary HP formulary and a secondary HP formulary. However, if the patient profile does not include an HP identification, then the HP formulary status is designated as unknown, and the present invention will terminate the secondary process. Alternatively, the secondary process begins by retrieving the HP coverage information associated with the HP identification. The HP coverage information describes the conditions and regulations of a patient's healthcare plan that need to be met in order for the patient to receive its benefits. The secondary process proceeds by comparing the patient's personal information and the specific drug's description information against the HP coverage information in order to determine HP exclusion factors for the patient and the specific drug. The HP exclusion factors could be any piece of information within the personal information or the drug description information that prevents the patient from receiving the benefits of their healthcare plan. The secondary process continues to use the HP coverage information and searches through the patient's personal information in order to find prior references to the specific drug. The prior references describe action to reference the patient's history in terms of taking the specific drug such as dosage or side effects.

After the secondary process analyzes the aforementioned data, the present invention can properly designate the HP formulary status. If the patient profile and the specific drug do not include said HP exclusion factors and if the patient profile does not include prior references to the specific drug, then the present invention will designate said HP formulary status as completely available. The completely available status provides the patient with full access to their healthcare plan's benefits for the specific drug. If the patient profile and the specific drug do not include the HP exclusion factors and if there are prior references to the specific drug, then the present invention will designate the HP formulary status as partially available. The partially available status requires a prescriber to take action, to provide input, or to review information in order for the patient to access their healthcare plan's benefits for the specific drug. If the patient profile and the specific drug do include the HP exclusion factors, then the present invention will designate the HP formulary status as non-reimbursable. The non-reimbursable status means the patient will not receive any benefits for the specific drug from their healthcare plan.

The present invention implements another secondary process in order to determine the cash-discount value. This secondary process is implemented in two different scenarios. In the first scenario, the specific drug is covered by a DM cash-discount formulary. The secondary process begins by searching through the cash-payment formulary for the specific drug in order to find a cash-payment value, which is the cost of the specific drug if the patient pays with cash. The secondary process continues by retrieving a cash-discount offer for the specific drug from the DM cash-discount formulary. The cash-discount offer further reduces the cost of the specific drug and can be, but is not limited to, a flat reduction for the cash-payment value, a free trial offer, or a combination thereof. The present invention will apply the cash-discount offer to the cash-payment value in order to determine the overall cash-discount value, which is displayed on the certified screen for the specific drug. In the second scenario, the specific drug is not covered by a DM cash-discount formulary. Similar to the first scenario, the secondary process begins by searching through the cash-payment formulary for the specific drug in order to find a cash-payment value. However, the present invention will just designate the cash discount value as the overall cash-payment value in the second scenario because there is no available cash-discount offer.

The present invention implements another secondary process in order to determine the overall copayment value. The present invention will implement this secondary process in three different scenarios. In the first scenario, the specific drug is covered by an HP formulary that is associated with the patient profile and is covered by a DM copayment-assistance formulary. The secondary process begins by retrieving an HP copayment value for the specific drug from the HP formulary and by retrieving a copayment-assistance offer for the specific drug from the DM copayment-assistance formulary. The HP copayment value is the cost the patient must pay if their healthcare plan covers the specific drug. The HP copayment value can be, but is not limited to, a flat rate, a percentage rate, or a tiered rate. The copayment-assistance offer is a discount for the patient copayment for the specific drug. The copayment-assistance offer value can be, but is not limited to, a flat cost reduction or a percentage cost reduction. The present invention will determine the overall copayment value by applying the copayment-assistance offer to the HP copayment value. In one embodiment of the present invention, the HP copayment value is displayed with the overall copayment value on the certified screen as a kind of minimum/maximum value, which allows the prescriber or the patient to see how much money they are saving by using the copayment-assistance offer. In the second scenario, the specific drug is covered by an HP formulary that is associated with the patient profile and is not covered by a DM copayment-assistance formulary. Similar to the first scenario, the secondary process begins by retrieving an HP copayment value for the specific drug from the HP formulary. However, the present invention will just designate the HP copayment value as the overall copayment value in the second scenario because there is no available copayment-assistance offer. In the third scenario, the specific drug is not covered by an HP formulary that is associated with the patient profile and is not covered by a DM copayment-assistance formulary. Consequently, the present invention will designate the HP copayment value as null, which means the patient will need to pay for the specific drug out of pocket. The present invention will also search through the HP formulary and different DM copayment-assistance formularies in order to find alternative drugs for the specific drug. This allows the prescriber or the patient to review the cost of similar drugs. For example, if the specific drug was a brand name drug, then the present invention could find alternative generic brand drugs.

Although the invention has been explained in relation to its preferred embodiment, it is to be understood that many other possible modifications and variations can be made without departing from the spirit and scope of the invention as hereinafter claimed.

1. A method of providing affordable prescription-drug options through a point of care system by executing computer-executable instructions stored on a non-transitory computer-readable medium, the method comprises the steps of:
providing a formulary database, wherein said formulary database includes a plurality of healthcare plan (HP) formularies, a cash-payment formulary, a plurality of drug manufacturers (DM) copayment-assistance formularies, and a plurality of DM cash-discount formularies;
accessing said formulary database through a point of care (POC) system;
receiving a drug search query for a patient profile through said POC system, wherein said patient profile includes personal information;
identifying a specific drug from said drug search query, wherein said specific drug includes drug description information;
searching through said HP formularies, said cash-payment formulary, said DM copayment-assistance formularies, and said DM cash-discount formularies in order to find matching references to said specific drug and said patient profile;
performing a cost correlation process for said specific drug with said matching references in order to determine an HP formulary status for said patient profile, an overall copayment value, an overall cash-discount value, and alternative-drugs information;
displaying a certified screen through said POC system, wherein said certified screen includes said HP formulary status, said overall copayment value, said cash discount value, and said alternative-drugs information; and
generating and sending a usage report to third party benefit-providing participants,
if said POC system writes a prescription for said specific drug,
wherein said usage report contains said prescription and said certified screen without patient-identifying information.

2. The method as claimed in claim 1, wherein said cash-payment formulary, said plurality of DM copayment-assistance formularies, and said plurality DM cash-discount formularies are provided in an interoperable format with said plurality of HP formularies.

3. The method as claimed in claim 1 comprises the steps of:
providing said patient profile with at least one HP identification;
retrieving HP coverage information associated with said HP identification;
comparing said personal information and said drug description information against said HP coverage information in order to determine HP exclusion factors for said patient profile and said specific drug;
searching through said personal information in order to find prior references to said specific drug within said patient profile;
designating said HP formulary status as non-reimbursable,
if said patient profile or said specific drug do include said HP exclusion factors;
designating said HP formulary status as partially available,
if said patient profile and said specific drug do not include said HP exclusion factors,
and if said patient profile and the HP coverage information does include said prior references to said specific drug; and
designating said HP formulary status as completely available,
if said patient profile and said specific drug do not include said HP exclusion factors,
and if said patient profile and the HP coverage information does not include said prior references to said specific drug.

4. The method as claimed in claim 3, wherein said HP formulary status as partially available requires prescriber action in terms of prior authorization, step therapy, or medical necessity.

5. The method as claimed in claim 3, wherein said HP identification refers either to a primary HP formulary or to a secondary HP formulary associated with said patient profile.

6. The method as claimed in claim 1 comprises the steps of:
designating said HP formulary status as unknown,
if said patient profile does not include an HP identification.

7. The method as claimed in claim 1 comprises the steps of:
wherein a specific drug is covered by a DM cash-discount formulary;
searching through said cash-payment formulary for said specific drug in order to find a cash-payment value;
retrieving a cash-discount offer for said specific drug from said DM cash-discount formulary; and
determining said overall cash-discount value by applying said cash-discount offer to said cash-payment value.

8. The method as claimed in claim 7, wherein said cash-discount offer is either a flat reduction for said cash-payment value, a free trial offer, or a combination thereof.

9. The method as claimed in claim 1 comprises the steps of:
wherein a specific drug is not covered by a DM cash-discount formulary;
searching through said cash-payment formulary for said specific drug in order to find a cash-payment value; and
designating said cash discount value as said overall cash-payment value.

10. The method as claimed in claim 1 comprises the steps of:
wherein said specific drug is covered by an HP formulary associated with said patient profile and is covered by a DM copayment-assistance formulary;
retrieving an HP copayment value for said specific drug from said HP formulary;
retrieving a copayment-assistance offer for said specific drug from said DM copayment-assistance formulary; and
determining said overall copayment value by applying said copayment-assistance offer to said HP copayment value.

11. The method as claimed in claim 1 comprises the steps of:
wherein said specific drug is covered by an HP formulary associated with said patient profile and is not covered by a DM copayment-assistance formulary;
retrieving an HP copayment value for said specific drug from said HP formulary; and
designating said HP copayment value as said overall copayment value.

12. The method as claimed in claim 1 comprises the steps of:
wherein said specific drug is not covered by an HP formulary associated with said patient profile;
designating said overall copayment value as null; and
searching through said HP formulary and DM copayment-assistance formularies in order to find said alternative drugs for said specific drug.

13. The method as claimed in claim 1 comprises the steps of:
identifying third party benefit-providing participants from said certified screen; and
addressing and sending said usage report to said benefit-providing participants.

14. The method as claimed in claim 1, wherein said benefit-providing participants create and update said cash-payment formulary, said plurality of DM copayment-assistance formularies, and said plurality DM cash-discount formularies.

15. The method as claimed in claim 1, wherein said certified screen further includes formulary coverage details for said specific drug.
